(19) United States
(12) Patent Application Publication
(10) Pub. No.: US 2024/0116024 A1
(43) Pub. Date: Apr. 11, 2024

(54) FLEXIBLE SORBENT POLYMER COMPOSITE ARTICLE HAVING ADSORPTIVE AND DESORPTIVE CONFIGURATIONS

(71) Applicant: W. L. Gore & Associates, Inc., Newark, DE (US)

(72) Inventors: Edward H. Cully, Newark, DE (US); Christine M. Scotti, Newark, DE (US)

(21) Appl. No.: 18/280,404

(22) PCT Filed: Mar. 7, 2022
(86) PCT No.: PCT/US2022/019104

§ 371 Date: Sep. 5, 2023

Related U.S. Application Data
(60) Provisional application No. 63/302,852, filed on Jan. 25, 2022.
(60) Provisional application No. 63/157,451, filed on Mar. 5, 2021.

(51) Int. Cl. B01J 20/28; B01D 53/04; B01J 20/26; B01J 20/34; C08J 9/00; C08J 9/35

(52) U.S. Cl. CPC B01J 20/2804; B01D 53/04; B01J 20/26; B01J 20/3466; C08J 9/0004; C08J 9/35; B01D 2253/202; B01D 2257/504; B01D 2259/4009; C08J 2203/06; C08J 2300/12

(57) ABSTRACT

A composite sorbent polymer composite article is disclosed for adsorption. The sorbent polymer composite article includes a sorbent and a flexible porous polymer, the sorbent polymer composite article having an adsorptive configuration in which the sorbent polymer composite article is configured to adsorb one or more components of a feed stream, and a desorptive configuration in which the sorbent polymer composite article is configured to remove one or more components from the sorbent polymer composite article.

### CROSS-REFERENCE TO RELATED APPLICATIONS

This application is a national phase application of PCT Application No. PCT/US2022/019104, internationally filed on Mar. 7, 2022, which claims priority to U.S. Provisional Application No. 63/157,451, filed on Mar. 5, 2021, and U.S. Provisional Application No. 63/302,852, filed on Jan. 25, 2022, the disclosure of each application being hereby incorporated herein by reference in its entirety.

### FIELD

The present disclosure relates to a sorbent polymer composite article, methods of forming a sorbent polymer composite article, and methods of using a sorbent polymer composite article for the purpose of adsorption, including adsorption for direct air capture (DAC) of carbon dioxide.

### BACKGROUND

Increasing carbon dioxide (CO₂) levels associated with greenhouse gas emission are shown to be harmful to the environment. As reported by the Climate.gov article “Climate Change: Atmospheric Carbon Dioxide,” the 2019 average CO₂ level in the atmosphere was 409.8 ppm, the highest level that has been noted in the past 800,000 years. The rate of increase of CO₂ in the atmosphere is also much higher than the rates in previous decades.

In order to limit climate change to acceptable levels, it is not only necessary to reduce CO₂ emissions in the near future to zero but also to achieve negative CO₂ emissions. Several possibilities exist in order to achieve negative emissions, e.g. combustion of biomaterials for the generation of electricity combined with CO₂ capture from the combustion flue gas and subsequent CO₂ sequestration (“BECCS”) or direct air capture of CO₂ (“DAC”).

Gas separation by adsorption has many different applications in industry, for example removing a specific component from a gas stream, where the desired product can either be the component removed from the stream, the remaining depleted stream, or both. Thereby, both trace components as well as major components of the gas stream can be targeted by the adsorption process. One important gas separation application is in capturing CO₂ from gas streams, e.g., from flue gases, exhaust gases, industrial waste gases, biogas or atmospheric air. Atmospheric air is considered a dilute feed stream of CO₂.

Capturing CO₂ directly from the atmosphere, referred to as DAC, is one of several means of mitigating anthropogenic greenhouse gas emissions and has attractive economic perspectives as a non-fossil, location-independent CO₂ source for the commodity market and for the production of synthetic fuels. The specific advantages of CO₂ capture from the atmosphere include: a) DAC can address the emissions of distributed sources (e.g. vehicles . . . land, sea and air), which account for a large portion of the worldwide greenhouse gas emissions and can currently not be captured at the site of emission in an economically feasible way; b) DAC can address legacy emissions and can therefore create truly negative emissions, and c) DAC systems do not need to be attached to the source of emission but may be location independent and can be located at the site of further CO₂ processing or usage.

There is increasing motivation to develop and improve upon these processes to make them more efficient, maximizing the amount of CO₂ removed from the atmosphere while minimizing the energy required in the process.

FIG. 1 is a schematic diagram of the process involved in a traditional DAC system 10. An input feed stream 11 is provided, containing a mixture of CO₂ molecules 16 in a non-CO₂ diluent 18. For example, the input feed stream 11 may be an air stream. During an adsorption process, the input feed stream 11 is exposed to an adsorbent 12. The CO₂ molecules 16 adsorb onto the adsorbent 12, while the non-CO₂ diluent 18 passes the adsorbent 12 and is exhausted from the system 10. The adsorbent 12 then undergoes a process of desorption in order to release the CO₂ molecules 16 from the adsorbent 12. The desorption process may involve moisture in the form of liquid water or steam or changes in the system temperature through reactions or energy delivered to the system. This desorption process is referred to as a “swing” adsorption to define the cyclic process of repeatedly adsorbing and desorption of CO₂. If moisture swing adsorption is being used, the adsorbent 12 may be exposed to moisture in the form of water vapor or liquid water to cause the desorption of the CO₂ molecules 16. If temperature swing adsorption is being used, heat may be applied to the adsorbent 12 to cause desorption of the CO₂ molecules 16. These moisture and/or temperature swings temporarily break the bonds that retain the molecules to the adsorbent 12 so that the CO₂ molecules 16 can be released. The desorbed CO₂ molecules 16 are thus separated from the adsorbent 12 and collected as the output 14. The collected CO₂ molecules 16 can then be concentrated and subjected to further necessary processes before being used or stored. It is important that the adsorbent 12 used is able to repeatedly withstand the environments necessary for separating the CO₂ molecules 16, such as high temperatures and high moisture conditions.

There are established articles and techniques for DAC. An example is using an article including a substrate such as a monolith that can support or be coated with a sorbent material. Variations are established by changing the type of substrate and the sorbent that is used. However, these previously established articles and methods present limitations in the ability to efficiently cycle between adsorbing and desorbing states. They also have limitations with respect to the durability of the article. The articles may also degrade when exposed to high temperatures or high moisture level environments, or combinations thereof, which can result in a shorter lifetime.

### SUMMARY

A sorbent polymer composite article is disclosed for adsorption. The sorbent polymer composite article includes a sorbent and a flexible porous polymer, the sorbent polymer composite article having an adsorptive configuration in which the sorbent polymer composite article is configured to adsorb one or more components from an input, and a desorptive configuration in which the sorbent polymer composite article is configured to remove the one or more components from the sorbent polymer composite article.

According to one example (“Example A”), a sorbent polymer composite article includes a composite of a sorbent and a flexible porous polymer having a flexibility and the sorbent polymer composite article has an adsorptive configuration in which the sorbent polymer composite article is configured to adsorb one or more components of a feed stream and a desorptive configuration in which the sorbent polymer composite article is configured to remove the one or more components from the sorbent polymer composite article. The flexibility of the flexible porous polymer facilitates a transfiguration between the adsorptive configuration and the desorptive configuration.

According to a second example (“Example B”), a method of using a sorbent polymer composite article includes the steps of providing the sorbent polymer composite article having a porous composite portion including a sorbent and a flexible porous polymer, exposing the sorbent polymer composite article in a first configuration to a feed stream containing carbon dioxide, adsorbing at least a portion of the carbon dioxide onto the sorbent while the sorbent polymer composite article is in the first configuration, positioning the sorbent polymer composite article into a second configuration after the adsorbing step, and desorbing the carbon dioxide from the sorbent polymer composite article while the sorbent polymer composite article is in the second configuration.

### BRIEF DESCRIPTION OF THE DRAWINGS

FIG. 1 is a schematic diagram of the process involved in a DAC system.

FIG. 2 is an elevational view of a sorbent polymer composite article of the present disclosure.

FIG. 2A is a schematic elevational view of the first composite region of the first composite article of FIG. 2.

FIG. 2B is a schematic elevational view of the first composite region of a compressed form of the first composite article of FIG. 2.

FIG. 2C is a schematic elevational view of the first composite region of a further compressed form of the first composite article of FIG. 2B.

FIG. 2D is an elevational view of the first sorbent polymer composite article of FIG. 2 illustrated with an end-sealing region of the present disclosure.

FIG. 3 is a flow chart showing a method of using the sorbent polymer composite article of FIG. 2.

FIG. 4A is a perspective view of a sorbent polymer composite article in a first, laminar configuration.

FIG. 4B is an elevational view of the sorbent polymer composite article of FIG. 4A in a second, rolled configuration.

FIG. 4C is a side view of a sorbent polymer composite article in a first, laminar configuration according to another embodiment disclosed herein.

FIG. 4D is an elevational view of the sorbent polymer composite article of FIG. 4C in a second, rolled configuration.

FIG. 5 is an elevational view of a continuous sorbent polymer composite article rotating between a first configuration and a second configuration.

FIG. 6A is an elevational view of a sorbent polymer composite article in a first, extended configuration.

FIG. 6B is an elevational view of the sorbent polymer composite article of FIG. 6A in a second, compressed configuration.

FIG. 6C is an elevational view of a sorbent polymer composite article in a first, extended configuration according to another embodiment disclosed herein.

FIG. 6D is an elevational view of the sorbent polymer composite article of FIG. 6C in a second, compressed configuration.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The term “fibril” as used herein describes an elongated piece of material such as a polymer, where the length and width are substantially different from each other. For example, a fibril may resemble a piece of string or fiber, where the width (or thickness) is much shorter or smaller than the length.

The term “node” as used herein describes a connection point of at least two fibrils, where the connection may be defined as a location where the two fibrils come into contact with each other, permanently or temporarily. In some examples, a node may also be used to describe a larger volume of polymer than a fibril and where a fibril originates or terminates with no clear continuation of the same fibril through the node. In some examples, a node has a greater width but a smaller length than the fibril.

As used herein, “nodes” and “fibrils” may be used to describe objects that are usually, but not necessarily, connected or interconnected, and have a microscopic size, for example. A “microscopic” object may be defined as an object with at least one dimension (width, length, or height) that is substantially small such that the object or the detail of the object is not visible to the naked eye or difficult, if not impossible, to observe without the aid of a microscope (including but not limited to a scanning electron microscope or SEM, for example) or any suitable type of magnification device.

### Description of Various Embodiments

The present disclosure relates to a sorbent polymer composite article, methods of forming a sorbent polymer composite article, and methods of using a sorbent polymer composite article to adsorb and separate one or more desired substances from a source stream. While the sorbent polymer composite article is described below for use in DAC of CO₂ from a dilute feed stream, such as air, it may also be used in other adsorbent methods and applications. These methods include, but are not limited to, adsorption of substances from various inputs, including other gas feed streams (e.g., combustion exhaust) and liquid feed streams (e.g., ocean water). The adsorbed substance is not limited to CO₂. Other adsorbed substances may include, but are not limited to, other gas molecules (e.g., N₂, CH₄, and CO), liquid molecules, and solutes. In certain embodiments, the input may be dilute, containing on the order of parts per million (ppm) of the adsorbed substance.

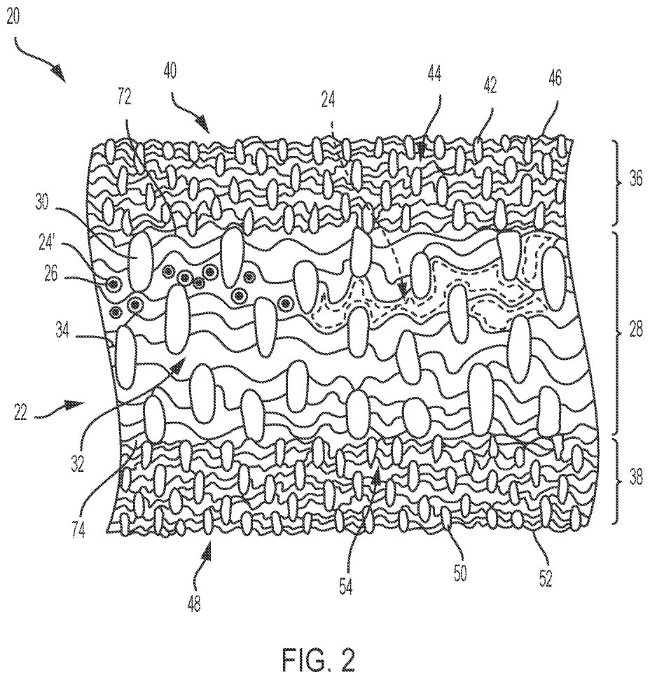

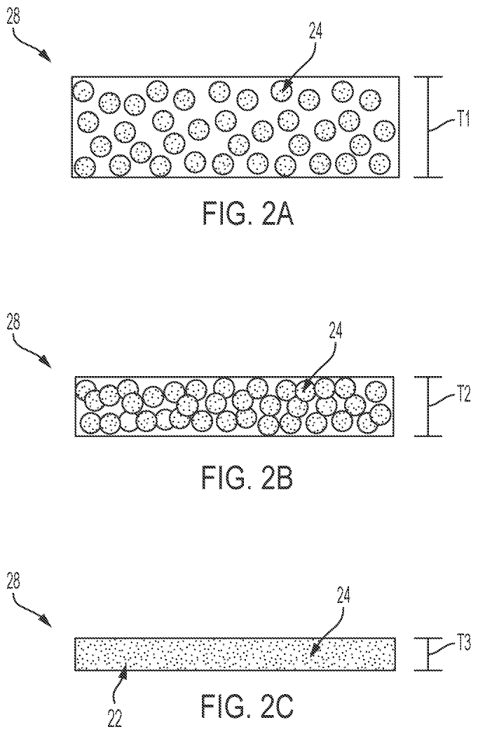

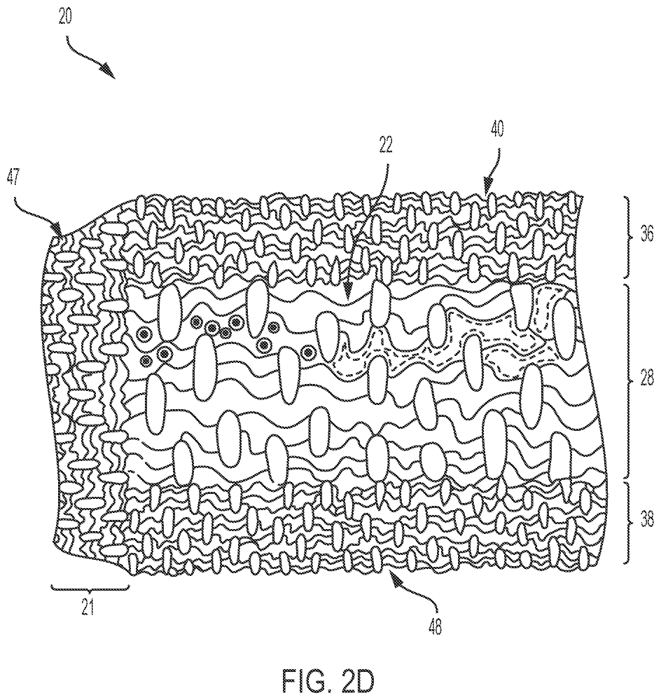

FIG. 2 shows a first exemplary sorbent polymer composite article 20 of the present disclosure including a first composite region 28. The first composite region 28 includes a first porous polymer 22 and a sorbent material 24, 24′. The first composite region 28 may also include an optional carrier 26. Each element of the first composite region 28 is described further below.

The first porous polymer 22 of the first composite region 28 may be one of expanded polytetrafluoroethylene (ePTFE), expanded polyethylene (ePE), polytetrafluoroethylene (PTFE), or another suitable porous polymer. It will be appreciated that non-woven materials such as nanospun, meltblown, spunbond and porous cast films could be among the various other suitable porous polymer forms. The first porous polymer 22 may be expanded by stretching the polymer at a controlled temperature and a controlled stretch rate, causing the polymer to fibrillate. Following expansion, the first porous polymer 22 may comprise a microstructure of a plurality of nodes 30 and a plurality of fibrils 34 that connect adjacent nodes 30. In these instances, the first porous polymer 22 includes pores 32 bordered by the fibrils 34 and the nodes 30. An exemplary node and fibril microstructure is described in U.S. Pat. No. 3,953,566 to Gore, incorporated herein by reference in its entirety. The pores 32 of the first porous polymer 22 may be considered micropores. Such micropores may have a single pore size or a distribution of pore sizes. The average pores size may range from 0.1 microns to 100 microns in certain embodiments.

The sorbent material 24, 24′ of the first composite region 28 is a substrate having a surface configured to hold the desired substance from the input on the solid surface via adsorption. The sorbent material 24, 24′ varies based on which substances are targeted for adsorption. In various embodiments, the sorbent material 24, 24′ is a carbon dioxide adsorbing material which may include, but is not limited to, an ion exchange resin (e.g., a strongly basic anion exchange resin such as Dowex™ Marathon™ A resin available from Dow Chemical Company), zeolite, activated carbon, alumina, metal-organic frameworks, polyethyleneimine (PEI), or another suitable carbon dioxide adsorbing material, such as desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, chemisorbent, amine, organo-metallic reactant, hydrotalcite, silicalite, zeolitic imadazolate framework and metal organic framework (MOF) adsorbent compounds, and combinations thereof.

The sorbent material 24, 24′ may be present in the first porous polymer 22 as a coating, a filling, entrained particles, and/or in another suitable form, as described further below. In the illustrated embodiment of FIG. 2, the first porous polymer 22 is coated with the sorbent material 24, such that the sorbent material 24 forms a substantially continuous coating on the nodes 30 and/or fibrils 34 of the first porous polymer 22. It is also within the scope of the present disclosure for the first porous polymer 22 to be filled with the sorbent material 24, such that the sorbent material 24 is incorporated into the nodes 30 and/or fibrils 34 of the first porous polymer 22. In the illustrated embodiment of FIG. 2, the particles of the sorbent material 24′ on the carrier 26 are entrained in the first porous polymer 22, such that the sorbent material 24′ occupies the pores 32 between the nodes 30 and fibrils 34 of the first porous polymer 22.

The optional carrier 26 of the first composite region 28 is a material that is configured to increase the surface area of the region it occupies which may allow for an increased surface area that is available for adsorption of the desired substance. The carrier 26 may include a mesoporous silica, polystyrene beads, porous polymeric bed or sphere, oxide supports, another suitable carrier material. The carrier 26 may further include porous film comprising porous inorganic materials within it such as calcium sulfate, alumina, activated charcoal and fumed silica. As noted above, the carrier 26 may be present in the pores 32 of the first composite region 28 as high surface area particles that are coated or functionalized with the sorbent material 24′. The combination of the carrier 26 coated with the sorbent material 24′ increases the surface area available for adsorption. In these embodiments, the nodes 30 and fibrils 34 may or may not be coated with sorbent material 24. When the nodes 30 and fibrils 34 are not coated, the original hydrophobicity of the first porous polymer 22 may be retained.

The first composite region 28 of the sorbent polymer composite article 20 includes a first side 72 (e.g., an upper side in FIG. 2) and a second side 74 (e.g., a lower side in FIG. 2). The sorbent polymer composite article 20 further includes a second region 36 comprising a second porous polymer 40, where the second region 36 is positioned adjacent to the first side 72 of the first composite region 28. In various embodiments, the sorbent polymer composite article also includes a third region 38 comprising a third porous polymer 48, where the third region 38 is positioned adjacent to the second side 74 of the first composite region 28. In this way, the first composite region 28 may be sandwiched between the second region 36 on the first side 72 and the third region 38 on the second side 74. The second porous polymer 40 of the second region 36 may comprise a plurality of nodes 42, a plurality of fibrils 46 that connect adjacent nodes 42, and a plurality of pores 44 that are each formed between the respective nodes 42 and fibrils 46. Similarly, the third porous polymer 48 of the third region 38 may comprise a plurality of nodes 50, a plurality of fibrils 52 that connect adjacent nodes 50, and a plurality of pores 54 formed between the respective nodes 50 and fibrils 52. The pores 44 of the second porous polymer 40 and/or the pores 54 of the third porous polymer 48 may be considered micropores, as described further above.

The first composite region 28, the second region 36, and the third region 38 of the sorbent polymer composite article 20 may be formed using different processes. In certain embodiments, the first composite region 28, the second region 36, and/or the third region 38 may be formed as discrete layers and then coupled together. In this case, the first porous polymer 22 of the first composite region 28, the second porous polymer 40 of the second region 36, and/or the third porous polymer 48 of the third region 38 may be distinct structures. In other embodiments, the first composite region 28, the second region 36, and/or the third region 38 may be formed together and then subjected to different coating processes or surface treatments, as described further below, to differentiate certain regions. In this case, the first porous polymer 22 of the first composite region 28, the second porous polymer 40 of the second region 36, and/or the third porous polymer 48 of the third region 38 may be continuous or integrated structures.

The first composite region 28, the second region 36, and the third region 38 of the sorbent polymer composite article 20 may have differing degrees of hydrophobicity. The hydrophobicity may be altered through various methods, such as through applying coatings or surface treatments which can include, but are not limited to, plasma etching and applying micro-topographical features. The first composite region 28 has a first hydrophobicity, the second region 36 may have a second hydrophobicity, and the third region 38 may have a third hydrophobicity. The first hydrophobicity is less than that of each the second hydrophobicity and the third hydrophobicity. The second hydrophobicity may be less than, greater than, or equal to the third hydrophobicity. The greater hydrophobicity of the second region 36 and the third region 38 may reduce the permeation of liquid water through the respective regions 36, 38, thus forming a barrier between any liquid water in the surroundings and the components of the first composite region 28. This reduces degradation of the sorbent material 24, 24′ within the first composite region 28 that liquid water could cause, increasing the lifetime and durability of the sorbent polymer composite article 20. The greater hydrophobicity of the second region 36 and the greater hydrophobicity of the third region 38 relative to the first hydrophobicity of the first composite region 28 may result from the lack of sorbent material 24, 24′ within the second and third regions 36, 38.

In some embodiments, the first composite region 28 is sealed with a coating (not shown). In certain instances, the coating is configured to be a carbon adsorbing material similar to the above-described sorbent materials 24, 24′.

The second porous polymer 40 of the second region 36 and the third porous polymer 48 of the third region 38 may be at least one of polytetrafluoroethylene (PTFE), expanded polytetrafluoroethylene (ePTFE), expanded polyethylene (ePE), or other suitable porous polymers. The second porous polymer 40 of the second region 36 may be identical to or different from the third porous polymer 48 of the third region 38. Further, the first porous polymer 22 of the first composite region 28, the second porous polymer 40 of the second region 36, and the third porous polymer 48 of the third region 38 may be identical to or different from each other.

In various embodiments, the thickness of the second region 36 is less than that of the first composite region 28, and the thickness of the third region 38 is less than that of the first composite region 28. The overall thickness of the sorbent polymer composite article 20 may be about 0.1 mm to about 5.0 mm. In certain embodiments, the thickness of the first composite region 28 may account for a majority of the overall thickness, such as about 70%, about 80%, about 90%, or more of the overall thickness.

The pore characteristics of the porous polymers 22, 40, 48 of each of the respective first composite region 28, the second region 36, and the third region 38 are variable. In certain embodiments, the second and third regions 36, 38 may have fewer and/or smaller pores 44, 54, than the first composite region 28 to selectively limit permeation of undesired contaminants (e.g., water) into the first composite region 28 while permitting permeation of desired molecules (e.g., CO₂) into the first composite region 28. By contrast, the first composite region 28 may have more and/or larger pores 32 than the second and third regions 36, 38 to encourage movement of CO₂ through the first composite region 28 for adsorption and desorption.

Further, the pore characteristics can be varied among different embodiments. This variation of the pore characteristics can be dependent on the entire thickness of the sorbent polymer composite article 20, as well as of the individual thicknesses of the first composite region 28, second region 36 and third region 38.

FIG. 2A is a schematic elevational view of the first composite region 28 of the sorbent composite article 20 of FIG. 2. In this embodiment, the sorbent polymer composite article 20 (FIG. 2) is relatively thick, for example approximately 3 mm, and the first composite region 28 has a thickness T1 that accounts for a majority of the overall thickness of the sorbent polymer composite 20. The sorbent polymer composite article 20 may be loaded with a desired amount of sorbent material 24 (e.g., about 60% sorbent material 24) to retain a relatively large void fraction, wherein the void fraction is a relative ratio of a volume of void space of the first composite region 28 to an entire volume of the first composite region 28. In this way, the sorbent polymer composite article 20 is relatively open in structure and there is relatively high accessibility of the sorbent material 24 While the distance required for diffusion of the gases may be farther in this embodiment due to the thickness T1, the sorbent material 24 remains accessible to the gases. As a result, the initial kinetics of the gas adsorbing to the sorbent material 24 may be slow, but the equilibrium of CO₂ adsorbing to the sorbent material 24 can be reached quickly in comparison to embodiments that are thinner, as will be described herein.

FIG. 2B is an alternate embodiment of the first composite region 28 of FIG. 2A wherein the sorbent composite article 20 (FIG. 2) has a median thickness, for example approximately 0.5 mm. In this embodiment, the first composite region 28 has a thickness T2 that accounts for the majority of the overall thickness of the sorbent polymer composite article 20. In this case, if the amount of polymer 22 (FIG. 2) of the first composite region 28 and the amount of sorbent material 24 is constant relative to the previous embodiment, the void fraction will be relatively smaller than the void fraction of the first composite region 28 of FIG. 2A. Thus, the sorbent polymer composite article 20 maintains a porosity wherein the gas is accessible to the sorbent material 24 but comparatively less accessible than the sorbent material 24 of the FIG. 2A embodiment. As a result, the initial kinetics of the gas adsorbing to the sorbent material 24 may be faster due to the shorter diffusion distance, but the time for equilibrium of CO₂ adsorption will increase relative to that of the embodiment in FIG. 2A.

FIG. 2C is alternate embodiment of the first composite region 28 of FIGS. 2A and 2B, wherein the sorbent polymer composite article 20 (FIG. 2) is relatively thin, for example approximately 0.1 mm. In this embodiment, the first composite region 28 has a thickness T3 that accounts for the majority of the overall thickness of the sorbent polymer composite article 20. In this case, if the amount of polymer 22 (FIG. 2) of the first composite region 28 and the amount of sorbent material 24 is constant relative to the previous two embodiments, the polymer 22 and available sorbent material 24 will be condensed even further within the sorbent polymer composite article 20. The diffusion distance required for the gases to pass through the article 20 is shorter due to the compressed thickness of the sorbent polymer composite article 20, but the sorbent material 24 is also less accessible to the gases. As a result, the initial kinetics of adsorption of the gases to the sorbent material 24 will be faster than the previous embodiments, but it may take longer for the system to reach a CO₂ adsorption equilibrium.

Referring back to FIG. 2, the pore characteristics of the sorbent polymer composite 20 may be varied within each layer, but also across various embodiments as a result of changing various characteristics, including the thickness of the sorbent polymer composite article 20, the thickness of the first composite region 28, the amount of sorbent material 24, 24′, and the amount of polymer 22 used within the sorbent polymer composite article 20. In this way, the relationship between diffusion length and sorbent material 24, 24′ accessibility can be varied for maximizing the function of the sorbent polymer composite article 20.

Further, the ability to vary the hydrophobicity, thickness, pore characteristics, and other properties of the first composite region 28, the second region 36, and the third region 38 may increase durability and conformability of the sorbent polymer composite article 20. Further, the use of a relatively thin and flexible sorbent polymer composite article 20 may allow the sorbent polymer composite article 20 to conform to different configurations for adsorption and desorption of the CO₂.

FIG. 2D is an additional elevational view of the sorbent polymer composite article of FIG. 2 with an additional end-sealing region 21. In certain embodiments, the sorbent polymer composite article 20 includes this end-sealing region 21 to protect the components of the sorbent polymer composite article 20. For example, if the sorbent polymer composite article 20 is cut or split in any manner, such as for production or manufacturing purposes, it may leave the first composite region 28, and thus the sorbent material 24, 24′ within the first composite region 28, exposed to external environment elements such as water, steam, or debris, which may be harmful to properties of the sorbent polymer composite article 20. Thus, embodiments with an end-sealing region 21 may be desirable. As illustrated in FIG. 2D, the end-sealing region 21 is positioned such that it may connect the polymer 40 of the second region 36 and the polymer 48 of the third region 38 and covers the exposed polymer of the first composite region 28 on at least one side.

In the illustrated embodiment of FIG. 2D, the end-sealing region 21 is formed by applying an additional layer of a sealing material 47 onto the sorbent polymer composite article 20. The sealing material 47 may be the same as or different from the materials of the second region 36 and the third region 38. For example, the sealing material 47 may be ePTFE (as shown in FIG. 2D), ePE, silicone elastomer, or any other suitable non-porous and/or hydrophobic material that protects the first composite region 28. In other embodiments, the end-sealing region 21 may be formed by extending the second region 36 and the third region 38 and coupling (e.g., pinching, adhering) the regions 36, 38 together. The addition of this edge sealing step will benefit the composite by protecting the sorbent(s) retained in the composite and also in toughening the leading edge of the composite (which is the area most likely to incur damage from airborne debris and high-velocity strikes).

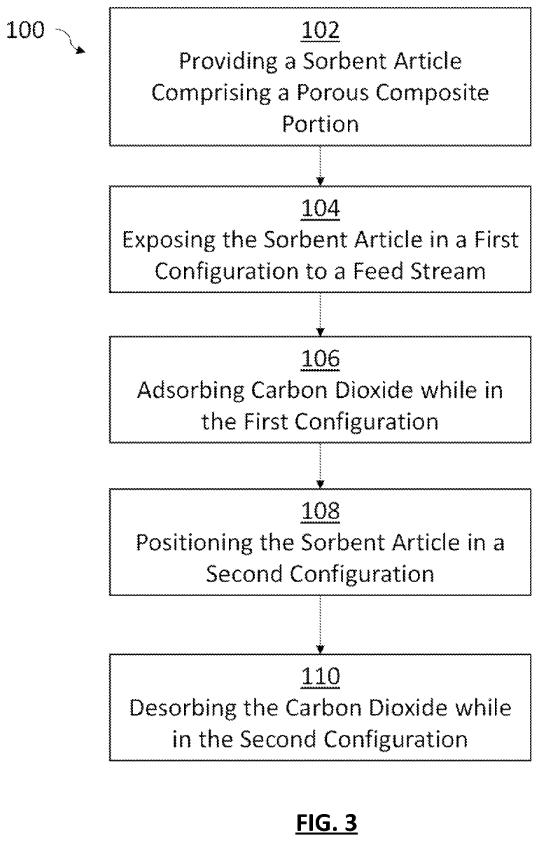

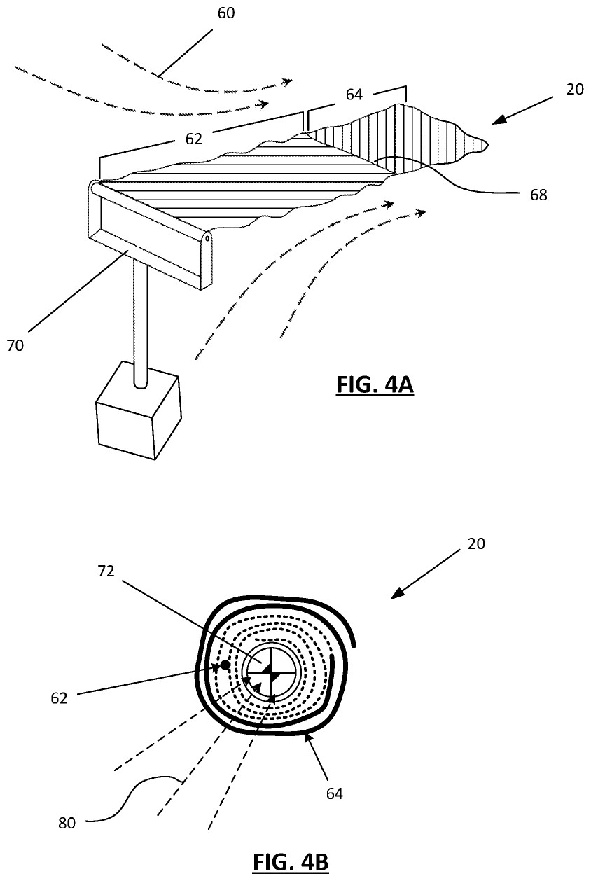

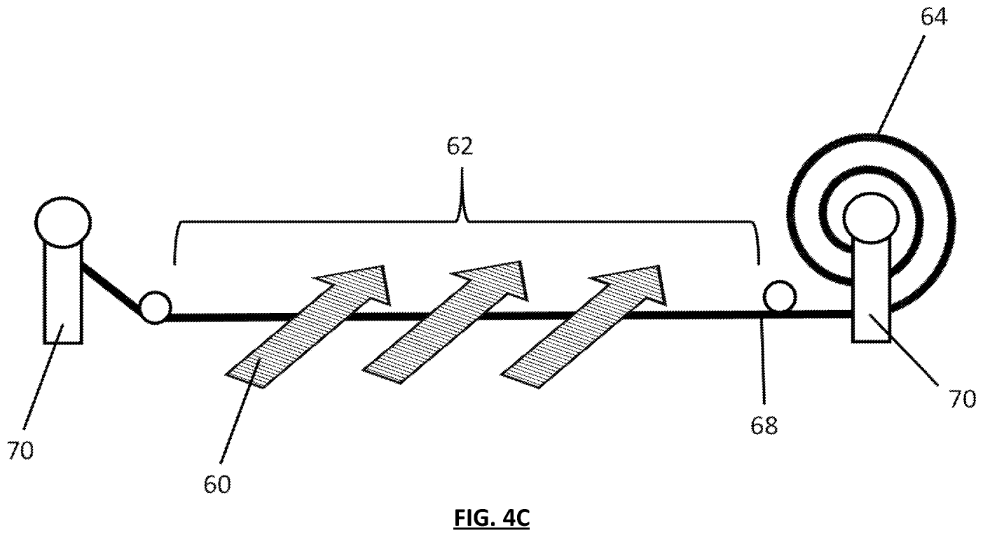

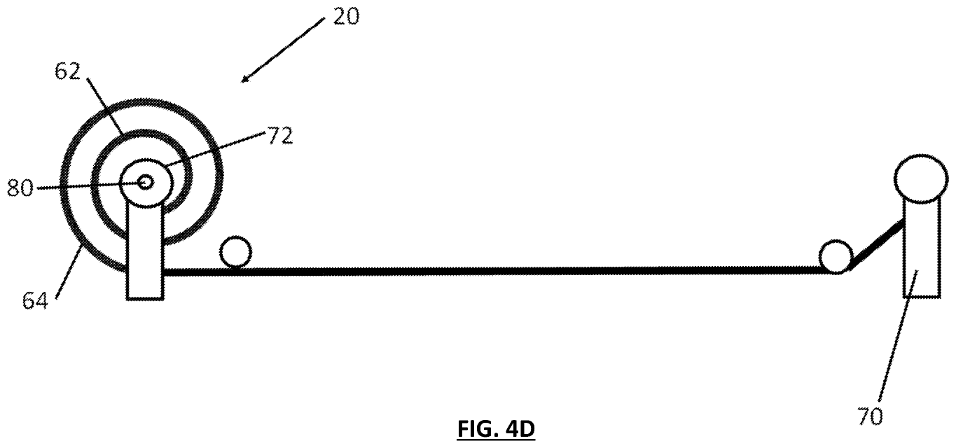

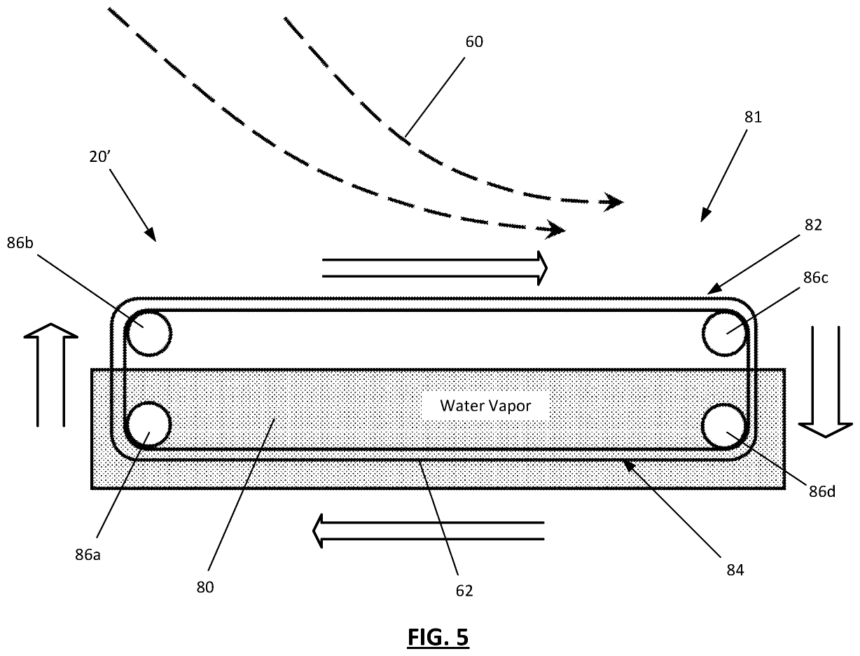

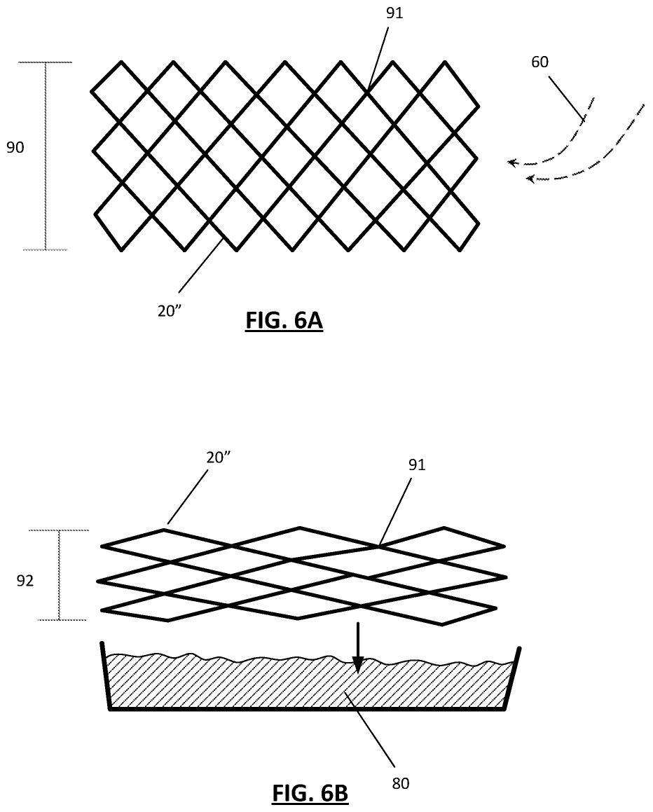

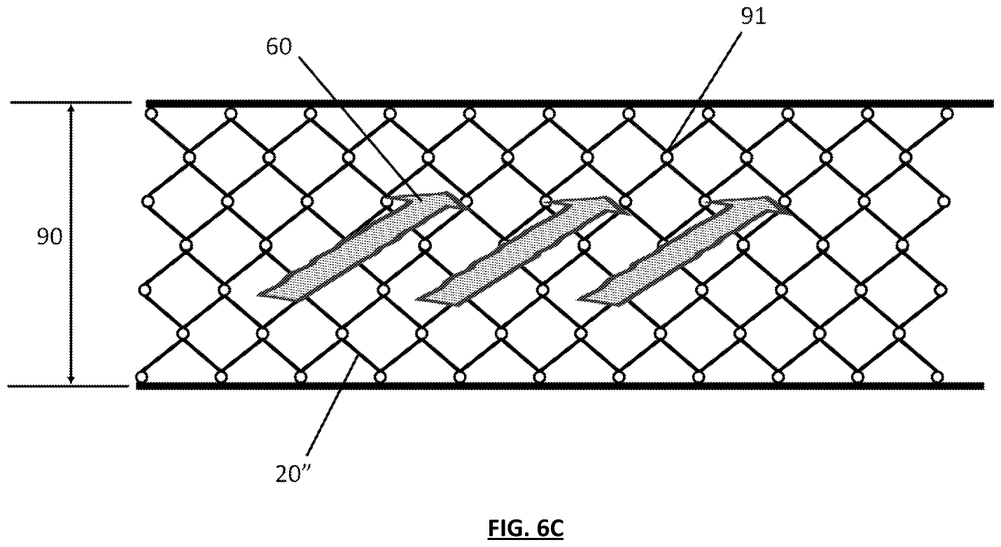

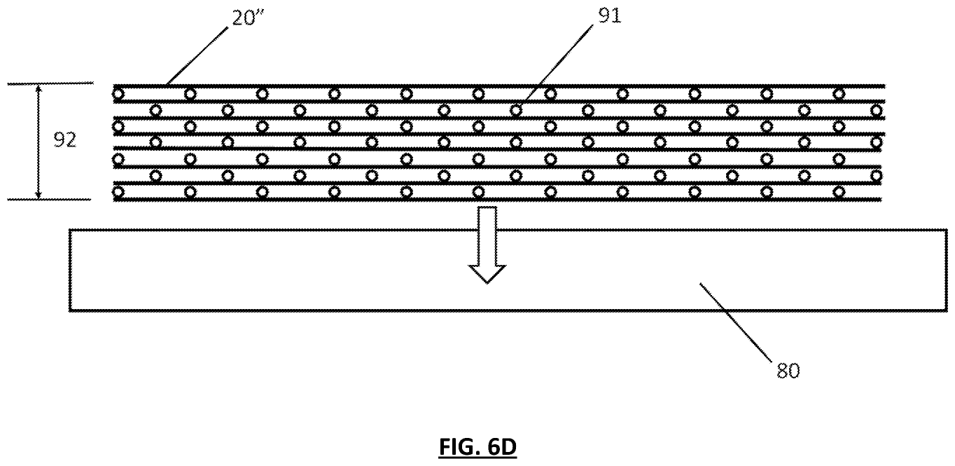

FIG. 3 is a flow chart illustrating a method 100 of using the sorbent polymer composite article 20 (FIG. 2) for DAC. While the method of using the sorbent polymer composite article 20 (FIG. 2) is described with reference to use for DAC, the method may be varied for use with different adsorption processes other than DAC. Examples of a first embodiment of this method 100 are shown in FIGS. 4A through 4D. Thus, method 100 will be initially described with reference to FIGS. 3, 4A, 4B, 4C, and 4D. Then, in the subsequent paragraphs, method 100 will be described with reference to FIG. 5 and FIGS. 6A through 6D.

At block 102, the method 100 first includes providing the sorbent polymer composite article 20 having a porous composite portion 62. In certain embodiments, the porous composite portion 62 includes the first composite layer 28 having the sorbent material 24, 24′ and the first porous polymer 22, the second layer 36, and the third layer 38 as shown and described above with respect to FIG. 2. In certain instances, block 102 may further include providing a non-porous portion 64 coupled to the porous composite portion 62 of the sorbent polymer composite article 20. In the embodiments of FIGS. 4A and 4C, the non-porous portion 64 is positioned at the outermost end 68 of the porous composite portion 62 of the sorbent polymer composite article 20. The lengths of the porous composite portion 62, the non-porous portion 64, and/or the total length of the sorbent polymer composite article 20 are variable.

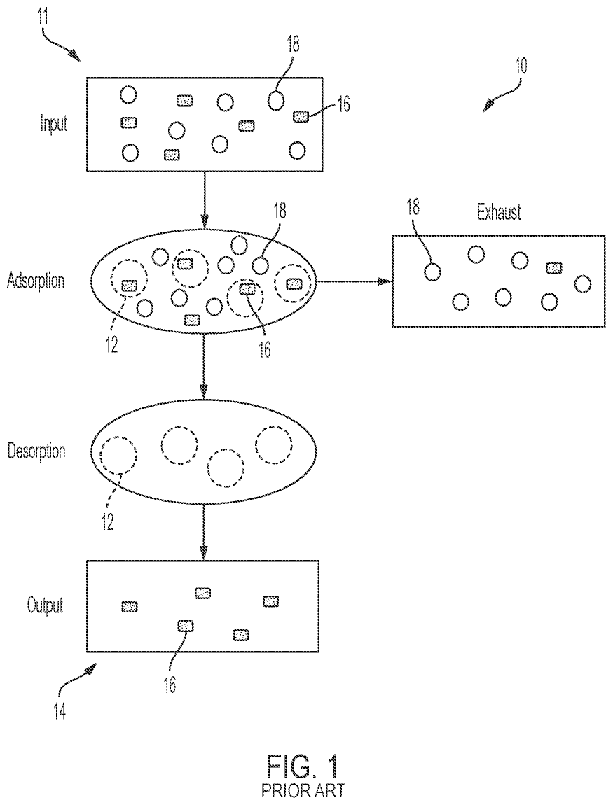

At block 104, the method 100 includes exposing the sorbent polymer composite article 20 in a first, adsorptive configuration to a feed stream 60. The sorbent polymer composite article 20 may have a substantially laminar form in the first configuration, examples of which are shown in FIGS. 4A and 4C, such that the porous portion 62 is exposed to the feed stream 60 without being concealed by the non-porous portion 64. In this first configuration, the sorbent polymer composite article 20 may be held by a support structure 70. The flexible nature of the sorbent polymer composite article 20 may allow the sorbent polymer composite article 20 to extend outwardly from the support structure 70 like a fabric flag or banner. Although a horizontal configuration is depicted in the exemplary embodiments of FIGS. 4A through 4D, additional multiple vertically oriented configurations are envisioned. In some instances, the sorbent polymer composite may be supported by structure 70 at each end of the sorbent polymer composite article 20 and the material traverses between the supports 70. In various embodiments, the feed stream 60 contains at least CO₂ and one other entity. The feed stream 60 may be similar to that of the input 11 shown and described with reference to FIG. 1. The feed stream 60 may be directed across the sorbent polymer composite article 20 in a substantially parallel direction, as shown in FIGS. 4A and 4C, a substantially perpendicular direction, or another suitable direction.

At block 106, the method 100 includes adsorbing the CO₂ onto the sorbent material 24, 24′ (FIG. 2) of the sorbent polymer composite article 20 while it is in the first configuration. In various embodiments, at least a portion of the CO₂ in the feed stream 60 is adsorbed onto the sorbent material 24, 24′ (FIG. 2) of the porous portion 62 of the sorbent polymer composite article 20. In certain instances, the sorbent polymer composite article 20 is maintained in the first configuration until an adsorption capacity for the CO₂ has been reached. This occurs when the amount of CO₂ adsorbed onto the sorbent material 24, 24′ of the sorbent polymer composite article 20 equals the maximum amount of CO₂ that the sorbent material 24, 24′ of the sorbent polymer composite article 20 can adsorb. It is also within the scope of the present disclosure to discontinue the adsorbing step of block 106 before the sorbent polymer composite article 20 reaches its adsorption capacity. For example, the kinetics of the system may be limited such that the amount of CO₂ adsorbed onto the sorbent material 24, 24′ reaches equilibrium and plateaus before reaching the adsorption capacity. In this example, the adsorbing step of block 106 may be discontinued when the amount of CO₂ adsorbed onto the sorbent material 24, 24′ plateaus.

At block 108, the method 100 includes positioning the sorbent polymer composite article 20 in a second, desorptive configuration after adsorbing CO₂ onto the sorbent polymer composite article 20 in the prior block 106. In certain instances, this positioning step of block 108 occurs after or before the adsorption capacity has been reached. The sorbent polymer composite article 20 may have a substantially rolled or spooled cylindrical form in the second configuration, with the porous portion 62 being rolled onto a porous drum 72 and the non-porous portion 64 being rolled onto the porous portion 62. As such, the inner, porous portion 62 may be concealed by the outer, non-porous portion 64 according to some examples. The non-porous portion allows vacuum to be applied within the porous drum 72. Applying a vacuum or negative pressure is a standard way of drawing off desorbed CO₂. In some examples, the porous portion 62 may be temporarily covered by the outer, non-porous portion 64, which may comprise one or more layers of non-porous material. In some examples, the porous portion 62 may be physically isolated, insulated, or protected from an external environment by the outer, non-porous portion 64.

At block 110, the method 100 includes desorbing the CO₂ while the sorbent polymer composite article 20 is in the second configuration by exposing the sorbent polymer composite article 20 to a desorption source 80 (e.g., water, water vapor, and/or heat). In the illustrated embodiments of FIGS. 4B and 4D, this desorbing step of block 110 includes injecting water vapor as the desorption source 80 longitudinally through the center of the sorbent polymer composite article 20 when in the second configuration. The end-sealing region 21 (FIG. 2) may protect the sorbent material 24, 24′. The energy needed for desorption may be minimized as compared to conventional systems, since the material is confined to a much smaller configuration during the desorption step. The sorbent polymer composite article 20 includes a degree of flexibility that facilitates the transfiguration between first and second configurations without the need for hinges and additional components. This desorbing step of block 110 may differ in alternate geographical regions, season, temperatures and weather.

The formation of water droplets may inhibit both adsorption from the feed stream 60 during the adsorbing step of block 106 and desorption of the CO₂ that occurs during the desorbing step of block 110. The feed stream 60 may contain sufficient water vapor for droplets to form on the sorbent polymer composite article 20 that impedes the adsorption of CO₂. Similarly, liquid droplets may condense on the sorbent polymer composite article 20 during desorption. In these circumstances, shaking, vibrating, oscillating, or otherwise moving the sorbent polymer composite article 20 may remove the liquid droplets from the sorbent polymer composite article 20. These techniques may improve the adsorption and desorption efficiency, respectively. This movability demonstrates a further benefit of the sorbent polymer composite article 20 in its flexibility. Various means of imparting motion to remove droplets will be known by those of skill in the art and may include physically vibrating the sorbent polymer composite article 20, shaking the structure 70, applying pulsed air, and/or oscillating the structure 70 through sound or magnetic variations, for example. This step of shaking or vibrating the sorbent polymer composite article 20 may occur simultaneously, before, and/or after, the exposing step of block 104, the adsorbing step of block 106, the positioning step of block 108, and the desorbing step of block 110.

In certain instances, the method 100 further includes collecting the CO₂ that was extracted. This collection process may be performed using a vacuum to collect the released CO₂.

Another embodiment of the method 100 of FIG. 3 relates to the use of the sorbent polymer composite article 20′ illustrated in FIG. 5. The sorbent polymer composite article 20′ may be similar to the above-described sorbent polymer composite article 20, with like reference numerals identifying like elements, except as described below.

In the illustrated embodiment of FIG. 5, the providing step of block 102 (FIG. 3) includes arranging a belt-shaped porous composite portion 62 along a continuous path 81 having a first portion 82 (e.g., an upper portion in FIG. 5) and a second portion 84 (e.g., a lower portion in FIG. 5). The exposing step of block 104 (FIG. 3), with the sorbent polymer composite article 20′ in the first configuration, includes positioning at least a portion of the porous composite 62 in the first (e.g., upper) portion 82 of the path 81 and in communication with the feed stream 60. The adsorbing step of block 106 (FIG. 3) includes adsorbing CO₂ from the feed stream 60 into the portion of the sorbent polymer composite article 20′ that is arranged in the first configuration. The positioning step of block 108 (FIG. 3), with the sorbent polymer composite article 20′ in the second configuration, includes positioning at least a portion of the porous composite 62 in the second (e.g., lower) portion 84 of the path 81 and in communication with the desorption source 80. The desorbing step of block 110 (FIG. 3) includes exposing the portion of the sorbent polymer composite article 20′ that is arranged in the second configuration to the desorption source 80 to desorb the CO₂. In the illustrated embodiment of FIG. 5, this desorption source 80 is water vapor (e.g., a greenhouse containing water vapor). In the greenhouse example, the released CO₂ may be used by the plants. In certain other embodiments, the extracted CO₂ may be collected after the desorbing step of block 110.

As shown in FIG. 5, the sorbent polymer composite article 20′ is supported by rollers 86a, 86b, 86c, 86d and may continuously rotate along the path 81. In this embodiment, the sorbent polymer composite article 20′ behaves as an endless track that continuously rotates between the first configuration when positioned in the first portion 82 of the path 81 and the second configuration when positioned in the second portion 84 of the path 81. In this way, each point along the length of the sorbent polymer composite article 20′ is able to undergo adsorption in the first configuration, desorption and regeneration when rotated into the second configuration, further adsorption when rotated back to the first configuration, and so on. The flexibility of the sorbent composite article 20 facilitates the transition between the first and second configurations without the need for additional components including but not limited to hinge components. This embodiment also allows adsorption and desorption to occur simultaneously with a single sorbent polymer composite article 20′. For example, adsorption may occur in the upper half of the sorbent polymer composite article 20′ that is positioned in the first configuration, and desorption may occur simultaneously in the lower half of the sorbent polymer composite article 20 that is positioned in the second configuration. The speed at which the sorbent polymer composite 20′ travels can be altered according to its capacity for adsorption and desorption or based on the kinetics when equilibrium is reached.

Another embodiment of the method 100 of FIG. 3 relates to the use of the sorbent polymer composite article 20″, examples of which are illustrated in FIGS. 6A through 6D. The sorbent polymer composite article 20″ may be similar to the above-described sorbent polymer composite article 20, with like reference numerals identifying like elements, except as described below.

In this embodiment, the first configuration corresponding to the exposing step of block 104 (FIG. 3) is an extended or unfolded configuration, examples of which are shown in FIGS. 6A and 6C, and the second configuration corresponding to the positioning step of block 108 (FIG. 3) is a compressed or folded configuration, examples of which are shown in FIGS. 6B and 6D. The sorbent polymer composite article 20″ may be a latticed construct having hinge points 91 to accommodate such unfolding and folding. In this embodiment, a height 90 of the sorbent polymer composite article 20″ is greater in the first, extended configuration than a height 92 of the sorbent polymer composite article 20″ in the second, compressed configuration.

In certain embodiments, the sorbent polymer composite article 20″ may comprise regions that contain the sorbent material 24 (e.g., filled regions) and regions that lack the sorbent material 24 (e.g., un-filled regions). The regions that lack the sorbent material 24 may be more conformable than those that contain the sorbent material 24. This ability to control the conformability of the sorbent polymer composite article 20″ may also allow for controlled positioning of the hinge points 91. Substances, such as silicone, may be entrained in the regions of the sorbent polymer composite article 20 that lack the sorbent material 24 to increase durability. The flexibility of the sorbent composite article 20 facilitates the translation between first and second configurations without the need for mechanical hinges and additional components, which would increase cost and decrease life span and durability.

Further, the desorbing step of block 110 (FIG. 3) may include exposing the sorbent polymer composite article 20″ to the desorption source 80. In the illustrated embodiments of FIGS. 6B and 6D, the desorption source 80 may be water, such that the desorbing step involves submerging the sorbent polymer composite article 20″ into the water to desorb the CO₂ while in the second, compressed configuration. In other embodiments, the desorption source 80 may be steam or heat. Those skilled in the art will clearly realize the energy sparing potential of minimizing the volume that the sorbent polymer composite occupies during the desorption step. This reduction in volume will result in reduction in energy usage and ultimately, cost.

Further benefits of a flexible sorbent polymer composite result from the capabilities of volume reduction (folding, rolling, spooling, etc). Minimizing the volume of an air contactor or module will allow reductions in storage space at the CO₂ capture site, inventory space at the manufacturing site and shipping and packaging costs. These benefits although listed, are not intended to be limiting. To explain further, the volume reducing benefits may be broad, such as in reduction of workers needed to replace the sorbent polymer composite of the present invention. For instance, in the deployed or adsorbtion configuration, the sorbent polymer composite may be bulky and require a team of technicians to handle and replace it whereas the folded or spooled sorbent polymer composite of the present invention may only require one technician to perform the same tasks that once took multiple technicians.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

1. A sorbent polymer composite article comprising a composite of a sorbent and a flexible porous polymer having a flexibility, the sorbent polymer composite article having:
an adsorptive configuration in which the sorbent polymer composite article is disposed to adsorb one or more components of a feed stream;
a desorptive configuration in which the sorbent polymer composite article is disposed to remove the one or more components from the sorbent polymer composite article; and
wherein the flexibility of the flexible porous polymer facilitates a transfiguration between the adsorptive configuration and the desorptive configuration.

2.-3. (canceled)

4. The sorbent polymer composite article of claim 1, wherein the sorbent polymer composite article is substantially laminar in the adsorptive configuration and substantially cylindrical in the desorptive configuration.

5. The sorbent polymer composite article of claim 1, wherein the sorbent polymer composite article comprises:
an extended arrangement in the adsorptive configuration; and
a compressed arrangement in the desorptive configuration.

6. The sorbent polymer composite article of claim 1, wherein the sorbent polymer composite article is substantially unfolded in the adsorptive configuration and substantially folded in the desorptive configuration.

7. The sorbent polymer composite article of claim 1, further comprising a non-porous portion that lacks the sorbent, wherein the non-porous portion is coupled to the composite.

8. The sorbent polymer composite article of claim 7, wherein the non-porous portion is coupled at an outermost end of the composite.

9. The sorbent polymer composite article of claim 7, wherein when the sorbent polymer composite article is in the desorptive configuration, the porous polymer of the composite is temporarily covered by the non-porous portion.

10. The sorbent polymer composite article of claim 1, wherein,
once an adsorption capacity or adsorption equilibrium of the sorbent polymer composite article has been reached, the sorbent polymer composite article transitions from the adsorptive configuration to the desorptive configuration, and wherein the sorbent polymer composite article returns from the desorptive configuration to the adsorptive configuration.

11. (canceled)

12. A method of using a sorbent polymer composite article comprising the steps of:
providing the sorbent polymer composite article comprising: a porous composite portion comprising a sorbent and a flexible porous polymer;
exposing the sorbent polymer composite article in a first configuration to a feed stream containing carbon dioxide;
adsorbing at least a portion of the carbon dioxide onto the sorbent while the sorbent polymer composite article is in the first configuration;
positioning the sorbent polymer composite article into a second configuration after the adsorbing step; and
desorbing the carbon dioxide from the sorbent polymer composite article while the sorbent polymer composite article is in the second configuration.

13. The method of claim 12, further comprising maintaining the sorbent polymer composite article in the first configuration until the sorbent reaches a carbon dioxide capacity or equilibrium, wherein the positioning step occurs once the carbon dioxide capacity or equilibrium has been reached.

14. The method of claim 12, wherein:
the providing step further comprises coupling a non-porous portion having a flexible polymer to the flexible porous polymer of the porous composite portion;
the exposing step further includes positioning the sorbent polymer composite article into a substantially laminar form; and
the positioning step further includes positioning the sorbent polymer composite article into a substantially cylindrical form with the porous composite portion concealed by the non-porous portion, and wherein the desorbing step comprises injecting water vapor into a center of the sorbent polymer composite article in the second configuration and collecting at least some of the carbon dioxide.

15. (canceled)

16. The method of claim 12, further comprising returning the sorbent polymer composite article from the second configuration to the first configuration subsequent to the desorbing step.

17. The method of claim 12, further comprising rotating the sorbent polymer composite article along a path having a first portion and a second portion, wherein:
during the exposing step with the sorbent polymer composite article in the first configuration, a portion of the sorbent polymer composite article is positioned in the first portion of the path; and
during the positioning step with the sorbent polymer composite article in the second configuration, a portion of the sorbent polymer composite article is positioned on the second portion of the path.

18. The method of claim 17, wherein the rotating step results in a reduced volume occupied by the sorbent polymer composite article.

19. The method of claim 17, wherein the desorbing step further includes submerging the porous composite portion in the second configuration in a substance to desorb the carbon dioxide.

20. (canceled)

21. The method of claim 12, further comprising collecting the extracted carbon dioxide subsequent to the desorbing step.

22. The method of claim 17, wherein the rotating step is performed continuously such that the sorbent polymer composite article continuously transitions between the first configuration and the second configuration.

23. The method of claim 12, wherein:
the exposing step includes positioning the sorbent polymer composite article in an extended configuration; and
the positioning step includes positioning the sorbent polymer composite article in a compressed configuration, wherein a height of the sorbent polymer composite article is greater in the extended configuration than a height of the sorbent polymer composite article in the compressed configuration, and wherein the desorbing step further includes submerging the sorbent polymer composite article in the second configuration in a substance that desorbs the carbon dioxide.

24.-25. (canceled)

26. The method of claim 12, wherein the sorbent polymer composite article further includes an end-sealing region that protects the sorbent.

27. The method of claim 12, further including moving the sorbent polymer composite article to substantially remove any liquid droplets.

28. (canceled)
